(19) United States
(12) Patent Application Publication
(10) Pub. No.: US 2010/0138429 A1
(43) Pub. Date: Jun. 3, 2010

(54) Method for building a file information table

(76) Inventors: Chun-Pin Lo, Taipei (TW); Yuan-Yu Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,921

(22) Filed: Apr. 24, 2009

(30) Foreign Application Priority Data
Dec. 1, 2008 (CN) 200810178769.7

(51) Int. Cl. G06F 7/00; G06F 12/00

(52) U.S. Cl. 707/752; 711/103; 711/E12.001; 711/E12.008; 707/E17.01

(57) ABSTRACT

A method for building a file information table is applied to an optical disk. The optical disk is stored with a plurality of directors and a path table. The method for building the file information table includes the following steps. Firstly, the path table is stored in a memory module. The logical block address of each of the directors is found from the path table in the memory module. The director information in the logical block address of each of the directors in the optical disk is read. Finally, the file information for each file of all directors is recorded to build the file information table in the memory module.

### BACKGROUND OF THE INVENTION

1. Field of the Invention

The present invention relates to a method for building a file information table. In particular, the present invention relates to a method for building a file information table of an optical disk

2. Description of Related Art

For storage optical disks, such as optical disks with ISO9660 optical storage format, the order of the addresses of the directors stored in the path table and the logical block addresses (LBA) in the track for the directors are different due to the different burning software. Because the directors are inversely or discontinuously stored, the optical disk drive needs to perform the frequently track seek to read the director information. Therefore, it takes a lot of time to build the file information table.

Reference is made to FIG. 1, which is the schematic diagram of the storage data distribution of the optical disk of the prior art. As shown in FIG. 1, the optical disk 1 is stored with a plurality of directors dir1˜dir7. The logical block addresses in sequence for the directors in the track are respectively dir1, dir7, dir6, dir5, dir4, dir3, dir2. The path table address for each director is orderly record in a path table (not shown in the figure), and the order of the directors are named by value of the path table address (it means that the order for the directors in the path table is dir1, dir2, dir3, dir 4, dir5, dir6, and dir7). After the optical disk drive reads the director information of the director dir1 and builds the file information table, the optical disk drive reads the next director dir2 according to the content of the path table. Although the separation between the path table address of director dir1 and the path table address of the director dir2 are most close, the optical disk drive takes a lot of time to seek to director dir2 from director dir1 continuously, or directly jump to the director dir2 to read data due to the logical block addresses for these two directors are farthest.

After the director dir2 has been processed, if the director dir3 is processed, the optical disk drive has to jump to the logical block address of the director dir3 and to read the content. The optical disk drive needs to perform the jump operation to read all information for the following directors. A lot of times for seeking will increase the time for building the file information table and the start-up time of the optical disk is increased. Especially, when the path table address of the directors is opposite to the logical block address (such as in FIG. 1), this problem becomes more serious.

### SUMMARY OF THE INVENTION

One particular aspect of the present invention is to provide a method for building a file information table that is used to copy the path table recorded the director address information to a memory and to rearrange the directors according to the order of the logical block addresses (LBA) that records the directors in the disk track. Thereby, without increasing the complication of the hardware or the software, the times of the seek operations can be reduced to improve the speed for building the file information table.

Another particular aspect of the present invention is to provide a method for building a file information table to improve the problem of the prior art.

The method for building a file information table is applied to an optical disk. The optical disk is stored with a plurality of directors and a path table. Each director stores a plurality of files. The path table records the logical block address located on the disk track, name, size and attribute of each of the directors. Each director records the address, name, size and attribute of each of the files which are stored in the directors. The method includes the following steps. Firstly, the path table is stored in a memory module. The logical block address for each director is orderly obtained from the path table in the memory module. Next, the data in the logical block address (LBA) for each director on the optical disk is read. Finally, the related information of each file of all directors is recorded to build a file information table on the memory module.

The present invention rearranges the directors on the path table according to the logical block addresses so that the optical disk drive can follow the track to read the files on the optical disk. Therefore, the times of seek track can be reduced to rapidly build the file information table of the optical disk.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a schematic diagram of the storage data distribution of the optical disk of the prior art;

FIG. 2 is a schematic diagram of the storage data distribution of the optical disk of the present invention;

FIG. 3 is a schematic diagram of the path table of the present invention;

FIG. 4 is a schematic diagram of the directors of the present invention;

FIG. 5 is a schematic diagram of the memory module of the present invention;

FIG. 6 is a flow chart of the method for building the file information table of the present invention;

FIG. 7 is a schematic diagram of the memory module of the present invention;

FIG. 8 is a flow chart of the method for building the file information table of the present invention;

FIG. 9 is a schematic diagram of the path table of the second embodiment of the present invention; and

FIG. 10 is a flow chart of the method for building the file information table of the present invention.

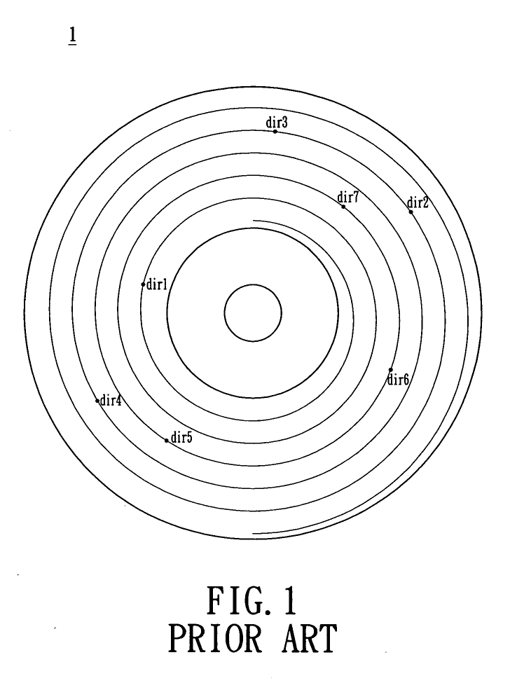

### DETAILED DESCRIPTION OF THE PREFERRED EMBODIMENTS

The method for building a file information table of the present invention rearranges the directors in the optical disk for reading according to the order of the logical block addresses (LBA) that records the directors in the disk track, so that the order of directors that are originally disorder can be orderly rearranged. Therefore, when the file information table of the optical disk is built, the times of seek can be reduced to shorten the startup time of the optical disk.

The characteristic of the present invention is to utilize the rearrangement of the directors in the path table to build the file information table. The method is a flow chart that is relative to the data in the optical disk being accessed into a memory module. The following merely discloses the main hardware and procedures. However, the skilled people should know that the data being record the memory module still includes the other necessary procedures. Therefore, the concept of the present invention is not limited to the following disclosure.

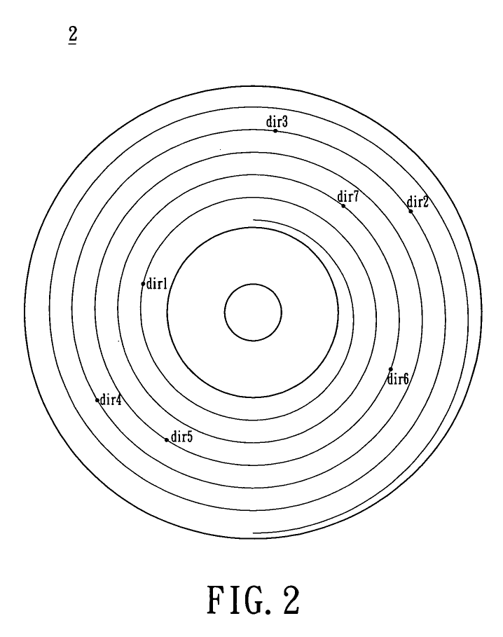

Reference is made to FIG. 2, which shows a schematic diagram of the storage data distribution of the optical disk of the present invention. As shown in FIG. 2, the optical disk 2 is stored with a plurality of directors dir1˜dir7. The logical block addresses of the directors and its order on the track is “dir1, dir7, dir6, dir5, dir4, dir3, dir2”.

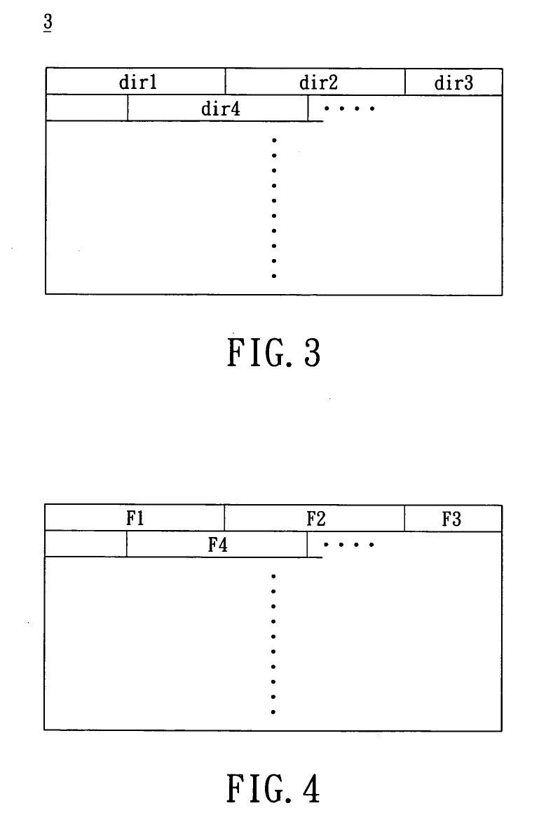

Reference is also made to FIG. 3, which shows a schematic diagram of the path table of the present invention. As shown in FIG. 3, the optical disk 2 further is stored with a path table 3 that orderly records the logical block addresses, names, sizes, attributes of the directors dir1˜dir7 according to the addresses value of the directors stored in the path table. The address value of the director dir1 is minimum, and the address value of the director dir7 is maximum. As shown in FIG. 4, each director stores a plurality of files F1, F2 . . . , and the director records the logical block address, name, size, attribute of each of the files. In other words, each optical disk 2 has a primary volume descriptor that records the logical block address of the path table 3.

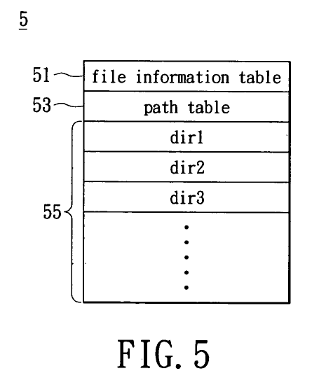

In order to generate the file information table of the optical disk 2, the user uses a computing system (not shown in the figure) to read data on the optical disk 2, and store the information of the files on the optical disk 2, such as logical block address, and name, etc, to a memory module. Reference is also made to FIG. 5, which shows a schematic diagram of the memory module of the present invention. As shown in FIG. 5, the memory module 5 provides a file information table storage space 51, a path table storage space 53 and a director storage space 55 for respectively storing the file information table, the path table 3 and the director information in the directors.

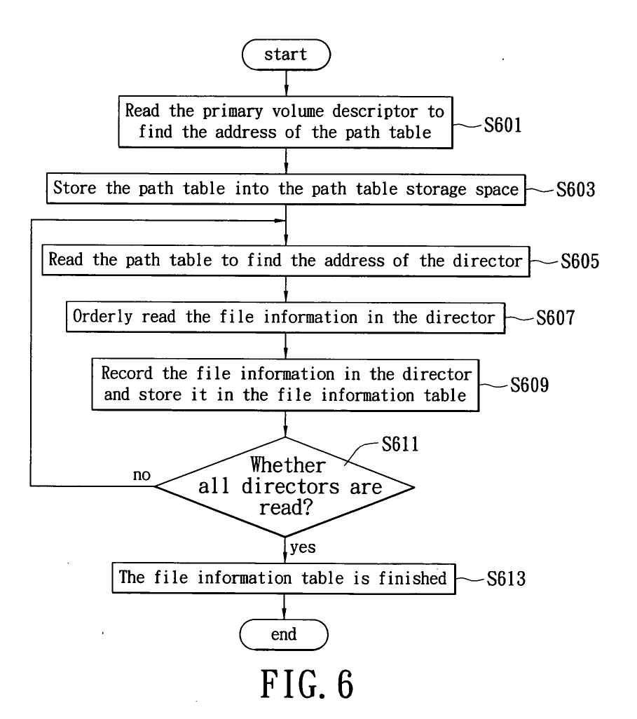

For one embodiment of the present invention, reference is made to FIG. 6 which is a flow chart of the method for building the file information table of the present invention. The related data structure and the data process type are referred to FIG. 2˜FIG. 5. As shown in FIG. 6, the method for building the file information table includes the following steps.

Firstly, the optical disk drive reads the primary volume descriptor in the optical disk 2 to find the logical block address (LBA) of the path table 3 (S601). The computing system copies the path table 3 to the path table storage space 53 of the memory module 5 (S603). The logical block address of the first director, director dir1, can be found from the path table 3 (S605). The computing system controls the optical disk drive to read the logical block address of the director dir1 on the optical disk 2, and orderly read the director information (including the sub-director, the file logical sector address, size, file name, and attribute, etc) in the director into the memory module 5 (S607). In one embodiment, the director information is obtained (not copy the file, obtaining the sub-director, the file logical sector address, size, file name, and attribute under the director) and stored in the director storage space 55. Next, the computing system builds the file information table according to the director information (S609).

After all the files in the director dir 1 are built in the file information table, the path table 3 is checked to determine whether all directors are read or not (S611). If all directors are not read, the path table 3 is checked to find the logical block address of the next director dir2, and all file information are recorded into the file information table. If all directors are read, the file information table is finished, and all files in the optical disk 2 are built in the file information table (S613).

In above embodiment, by storing temporarily the path table 3 of the optical disk 2 in the memory module 5 in advance, the computing system can directly obtain the logical block address of the director from the path table 3 in the memory module 5 and controls the optical disk drive to seek to the logical block address of the director to read the director information. Thereby, the problem of seeking to the path table 3 in the optical disk 2 to find the next director when one director is processed is avoided. The times of seek for the optical disk drive is reduced, and the time for building the file information table is shortened.

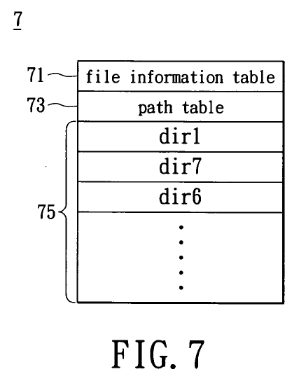

In one embodiment, by rearranging the directors in the path table 3, the required time for building the file information is reduced. Reference is made to FIG. 7, which is a schematic diagram of the memory module of the present invention. As shown in FIG. 7, the memory module 7 provides a file information table storage space 71, a path table storage space 73, and a director storage space 75 for respectively storing the file information table, the path table 3, and the director information in the directors.

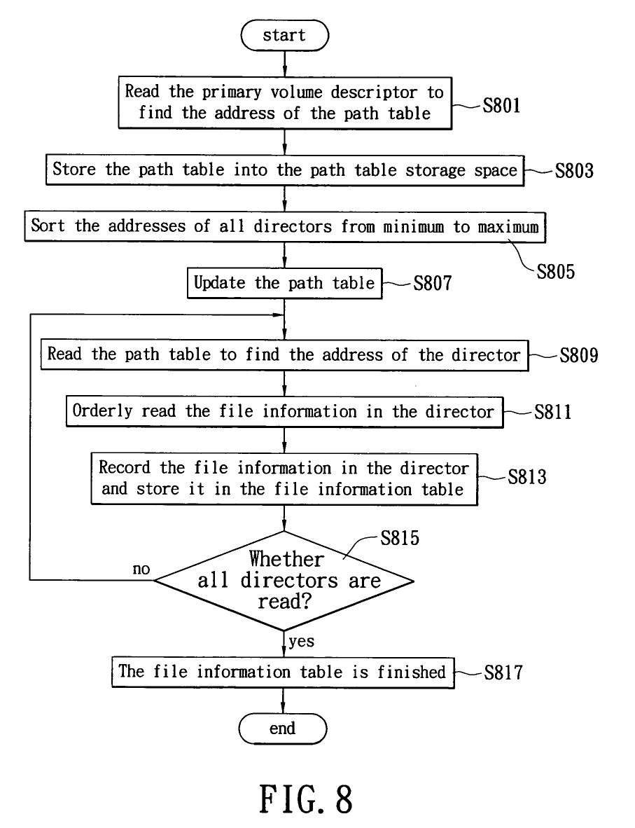

Reference is made to FIG. 8, which is a flow chart of the method for building the file information table of the present invention. As shown in FIG. 8, the method for building the file information table includes the following steps.

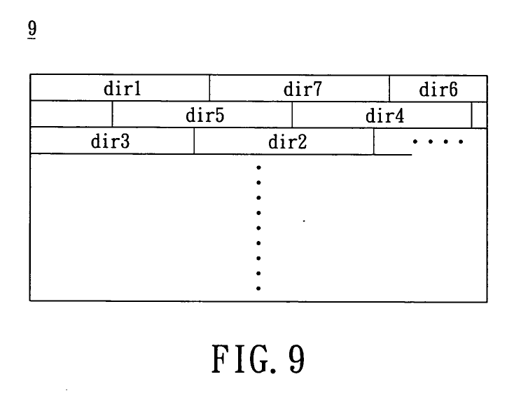

Firstly, the optical disk drive reads the primary volume descriptor in the optical disk 2 to find the logical block address (LBA) of the path table 3 (S801). The computing system copies the path table 3 to the path table storage space 73 of the memory module 7 (S803), and sorts the directors in the path table 3 according to the logical block address of the directors from minimum to maximum (S805). In one embodiment, by using bubble sorting method, the order of the logical block addresses of the directors is stored temporarily in the director storage space 75 and is processed. The sorted path table is referred to FIG. 9. As shown in FIG. 9, the order of the directors has been sorted to “dir1, dir7, dir6, dir5, dir4, dir3, dir2” that is the order of the logical block address of the directors in the track. The logical block address value of the director dir1 is minimum, and the director dir1 is stored at the track that is closest to the center of the optical disk 2. The logical block address value of the director dir2 is maximum, and the director dir2 is stored at the track that is farthest to the center of the optical disk 2. After the directors are sorted, the sorted path table 9 is updated to the path table storage space 73 (S807).

Next, the logical block address of the director dir1 can be found from the path table 9 (S809). The computing system controls the optical disk drive to read the logical block address of the director dir1 on the optical disk 2, and orderly read the director information in the director into the memory module 7 (S811). In one embodiment, the files are copied to the director storage space 75 and stored temporarily in it. Next, the computing system processes the director information in the director, including recording the file addresses, accessing ways, and names, etc, and stores the director information into the file information table (S813).

After all the files in the director dir1 are built in the file information table, the path table 9 is checked to determine whether all directors are read or not (S815). If all directors are not read, the path table 9 is checked to find the logical block address of the next director dir7, and all file information are recorded into the file information table. If all directors are read, the file information table is finished, and all files in the optical disk 2 are built in the file information table (S817).

In above embodiment, by storing the path table 9 of the optical disk 2 in the memory module 7 and sorting the logical block addresses of the directors, the problem of the computing system controlling the optical disk drive to seek to the path table 9 in the optical disk 2 to find the next director when one director is processed is avoided. Thereby, the optical disk drive can follows the track to read the director information from the inner director dir1 to the most outer director dir2. The times of seek for the optical disk drive is reduced, and the time for building the file information table is shortened.

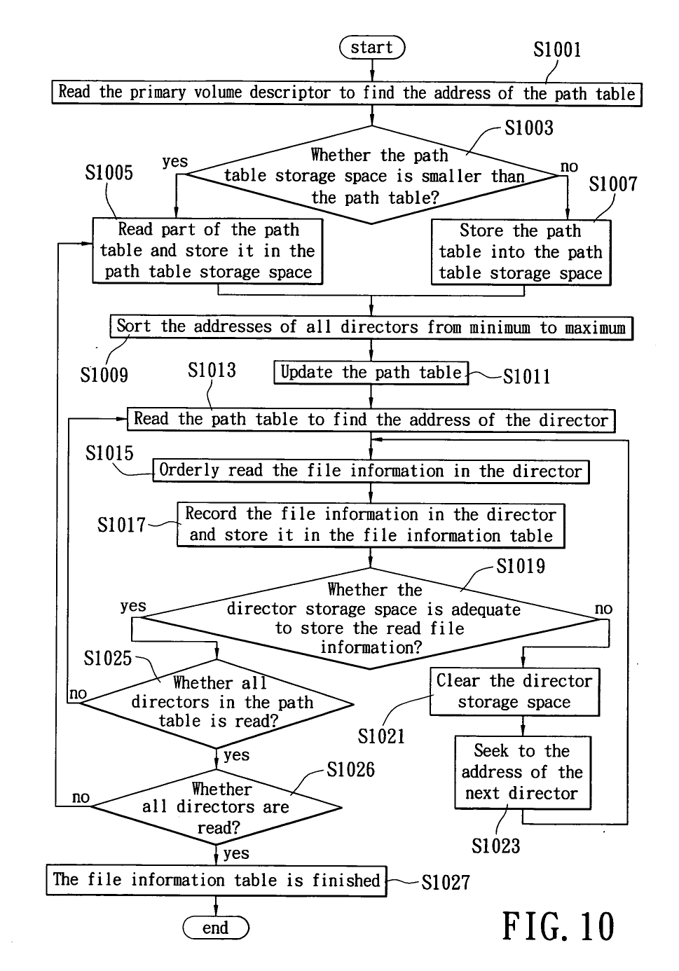

However, due to the limitation of the cost and space of the memory module 7, the path table storage space 73 and the director storage space 75 will be inadequate when the path table 9 in the optical disk 2 and the number of the directors is too large. In order to solve the above problem, the method for solving the resource limitation problem is disclosed. Reference is made to FIG. 10, which is a flow chart of the method for building the file information table of the present invention. The data structure and the data process type are also referred to FIGS. 2, 3, 7 and 9. As shown in FIG. 10, the method for building the file information table includes the following steps.

Firstly, the optical disk drive reads the primary volume descriptor in the optical disk 2 to find the logical block address (LBA) of the path table 3 (S1001). Next, whether the path table storage space 73 is smaller than the path table 3 is determined (S1003). If the path table storage space 73 is not smaller than the path table 3, it means that the path table storage space 73 can receive all the path table 3, and the computing system copies the path table 3 to the path table storage space 73 of the memory module 7 (S1007). If the path table storage space 73 is smaller than the path table 3, it means that the path table 3 is too large, and the path table 3 needs to be read into the path table storage space 73 in several segments. In one embodiment, the path table 3 is orderly divided into a plurality of divided path table. Each divided path table is smaller than the path table storage space 73. The first divided path table is copied to the path table storage space 73 of the memory module 7 (S1005).

Next, the order of the directors of the path table 9 in FIG. 9 are generated according to the logical block address (LBA) value of the directors stored temporarily in the path table storage space 73 from minimum to maximum (S1009). After the directors are sorted, the sorted path table 9 is updated onto the path table storage space 73 (S1011) to record the directors and the related information of the files into the file information table.

The logical block address of the first director dir1 is found from the path table 9 (S1013). The computing system controls the optical disk drive to read the logical block address (LBA) of the director dir1 on the optical disk 2, and orderly read the director information in the director into the memory module 7 (S1015). In one embodiment, the files are copied to the director storage space 75 and stored temporarily in it. Next, the computing system processes the director information in the director, including recording the logical block addresses, accessing ways, and names of the file, etc, and stores the director information into the file information table (S1017).

After all the files in the processed director are built in the file information table, whether the director storage space 75 is adequate to store the director information of the next director is determined (S1019). If the director storage space 75 is not adequate to store the director information of the next director, it means that the next director cannot be read in the track-following way. The director storage space 75 will be cleared, and a seek operation is performed to jump to the logical block address (LBA) of the next director (S1023) and process the files in the director by the same way.

If the director storage space 75 is adequate to store the director information of the next director, the path table 9 is checked to determine whether all directors are read or not (S1025). If all directors are not read, the path table 9 is checked to find the logical block address (LBA) of the next director dir 7, and all file information are recorded in the file information table. If all directors are read, whether the entire path table 3 is read determined (S1026)? If the entire path table 3 is not read, the step 1005 is performed to read the residual divided path table into the path table storage space 73 and sort it. If the entire path table 3 is read, it is means that the file information table is finished, and all files in the optical disk 2 are built in the file information table (S1027).

In one embodiment, in order to fully utilize the system resource, the path tables 3, 9 copied on the path table storage spaces 53, 73 are the simplified content of the path table 3 stored in the optical disk 2, such as the logical block address (LBA) information of all directors. Thereby, more director information can be stored within the limited storage space.

In one embodiment, the memory modules 5, 7 are flash memory, AND-flash memory, OR-flash memory, NAND-flash memory, read only memory (ROM), erasable read only memory (EROM), electrically erasable read only memory (EEROM), erasable programmable read only memory (EPROM), or electrically erasable programmable read only memory (EEPROM).

The method for building the file information table of the present invention stores the path table in the memory in advance to prevent the optical disk drive from seeking to the path table to find the next director when one director is processed. Moreover, the directors in the path table are sorted according to logical block addresses to meet the order of the directors recorded on the track. By using the above ways, when the optical disk drive orderly read the director information in the directors, the optical disk drive reads the director information from the inner track to the most outer track of the optical disk by a track-following way. The times of the seek performed by the optical disk drive can be reduced, and the required time for reading the director information is reduced to reduce the required time for building the file information table.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A method for building a file information table, being applied to an optical disk, wherein the optical disk is stored with at least one director and a path table and each director is stored with a director information, comprising:
storing the path table into a memory module;
sorting the directors according to logical block addresses of the directors;
storing the sorted directors into the path table;
reading the director information in the logical block address of the director in the optical disk according to the sorted path table; and
building the file information table in the memory module according to the director information.

2. The method for building the file information table as claimed in claim 1, wherein the optical disk has a primary volume descriptor and the primary volume descriptor records the logical block address of the path table, and the method further comprises:
reading the primary volume descriptor to find the logical block address of the path table.

3. The method for building the file information table as claimed in claim 2, wherein the path tables stored into the memory module merely includes the information of the logical block address of the director.

4. The method for building the file information table as claimed in claim 3, wherein the memory module provides a path table storage space for storing the path table, and a director storage space for storing temporarily the director information.

5. The method for building the file information table as claimed in claim 4, wherein the step of storing the path table into the memory module further comprises:
determining whether the path table storage space is smaller than the path table; and
if the path table storage space is smaller than the path table, the following steps are performed:
dividing the path table into a plurality of divided path tables, wherein each divided path table is smaller than the path table storage space; and
reading one of the divided path tables into the path table storage space.

6. The method for building the file information table as claimed in claim 5, wherein the step of storing the sorted directors into the path table further comprises:
determining whether the last divided path table is stored in the path table storage space; and
if the last divided path table is not stored in the path table storage space, orderly storing the residual divided path tables into the path table storage space, and recording the related directors and the file information into the file information table.

7. The method for building the file information table as claimed in claim 6, wherein the step of recording the related directors and the file information into the file information table further comprises:
reading a first director information into the director storage space and recording the first director information into the file information table;
determining whether the director storage space is smaller than the size of the information in the directors; and
if the director storage space is smaller than the size of the information in the directors, the following steps are performed:
clearing the content in the director storage space; and
orderly reading a next director information into the director storage space, and recording the next director information into the file information table until the director information of all directors are built into the file information table.

8. The method for building the file information table as claimed in claim 1, wherein the memory module is a flash memory, an AND-flash memory, an OR-flash memory, a NAND-flash memory, a read only memory, an erasable read only memory, an electrically erasable read only memory, an erasable programmable read only memory, or an electrically erasable programmable read only memory.

9. A method for building a file information table, being applied to an optical disk, wherein the optical disk is stored with at least one director and a path table and each director is stored with a director information, comprising:
storing the path table that merely includes logical block address of the director into a memory module;
finding the logical block addresses of the directors from the path table in the memory module in sequence;
reading the director information in the logical block address of the director in the optical disk; and
building the file information table in the memory module according to the director information.

10. The method for building the file information table as claimed in claim 9, wherein the memory module provides a path table storage space for storing the path table and a director storage space for storing temporarily the director information.

11. The method for building the file information table as claimed in claim 10, wherein the step of storing the path table into the memory module further comprises:
determining whether the path table storage space is smaller than the path table or not; and
if the path table storage space is smaller than the path table, the following steps are performed:
dividing the path table into a plurality of divided path tables, wherein each divided path table is smaller than the path table storage space; and
reading one of the divided path tables into the path table storage space.

12. The method for building the file information table as claimed in claim 11, wherein the step of reading one of the divided path tables into the path table storage space further comprises:
determining whether the last divided path table is stored in the path table storage space; and
if the last divided path table is not stored in the path table storage space, orderly storing the residual divided path tables into the path table storage space, and recording the related directors and the file information into the file information table.

13. The method for building the file information table as claimed in claim 12, wherein the step of recording the file information in the director further comprises:
reading a first director information into the director storage space and recording the first director information into the file information table;
determining whether the director storage space is smaller than the size of the information in the directors; and
if the director storage space is smaller than the size of the information in the directors, the following steps are performed:
clearing the content in the director storage space; and
orderly reading a next director information into the director storage space, and recording the director information into the file information table until the director information of all directors are built into the file information table.
